(19) United States
(12) Patent Application Publication
(10) Pub. No.: US 2026/0186138 A1
(43) Pub. Date: Jul. 2, 2026

(54) DISTANCE MEASURING APPARATUS, DISTANCE MEASURING METHOD, NON-TRANSITORY RECORDING MEDIUM, AND AUTOMATIC PARKING CONTROL METHOD

(71) Applicant: Panasonic Automotive Systems Co., Ltd., Kanagawa (JP)

(72) Inventors: Wataru HIRATA, Kanagawa (JP); Hiroki YAMASHITA, Kanagawa (JP); Yuya HAMAI, Kanagawa (JP); Takeo TOMIDA, Kanagawa (JP); Yoshiki MATSUSHITA, Kanagawa (JP)

(73) Assignee: Panasonic Automotive Systems Co., Ltd., Kanagawa (JP)

(21) Appl. No.: 19/429,651

(22) Filed: Dec. 22, 2025

(30) Foreign Application Priority Data
Dec. 26, 2024 (JP) 2024-230262

(51) Int. Cl. G01S 15/931; B60W 30/06

(52) U.S. Cl. CPC G01S 15/931; B60W 30/06; B60W 2420/54; B60W 2554/20; B60W 2554/801; B60W 2554/802; G01S 2015/932

(57) ABSTRACT

A distance measuring apparatus according to the present disclosure includes: a detector that detects, in a graph, a local maximum point of a received wave intensity of a reflected wave resulting from reception of an ultrasonic wave that has been transmitted and then reflected by an object, the graph indicating a relationship between the received wave intensity and a time of flight of the ultrasonic wave; and a distance measurer that calculates, when a plurality of the local maximum points is present within a range in which the received wave intensity is equal to or greater than a predetermined threshold in the graph, a distance to the object based on the time of flight at a local maximum point whose received wave intensity is lowest among the plurality of local maximum points.

### TECHNICAL FIELD

The present disclosure relates to a distance measuring apparatus and a distance measuring method each measures a distance to a surrounding object based on a reflected wave of transmitted ultrasonic waves, and also to a non-transitory recording medium, and an automatic parking control method of a vehicle equipped with a distance measuring apparatus.

### BACKGROUND ART

A parking assist apparatus has been developed, which detects a wheel stopper (wheel chock) that is a structure capable of stopping a vehicle by coming into contact with a wheel of the vehicle and which automatically parks the vehicle according to the detected wheel stopper.

### CITATION LIST

### Patent Literature

PTL 1
Japanese Patent Application Laid-Open No. 2019-127189

### SUMMARY OF INVENTION

A distance measuring apparatus according to one aspect of the present disclosure includes: a detector that detects a local maximum point of a received wave intensity of a reflected wave resulting from reception of an ultrasonic wave that has been transmitted and then reflected by an object; and a distance measurer that calculates, when a plurality of the local maximum points is present within a range in which the received wave intensity is equal to or greater than a predetermined threshold, a distance to the object based on a time of flight of the ultrasonic wave at a local maximum point whose received wave intensity is lowest among the plurality of local maximum points.

A distance measuring method according to one aspect of the present disclosure, includes, executed by a computer: a process of detecting a local maximum point of a received wave intensity of a reflected wave resulting from reception of an ultrasonic wave that has been transmitted and then reflected by an object; and a process of calculating, when a plurality of the local maximum points is present within a range in which the received wave intensity is equal to or greater than a predetermined threshold, a distance to the object based on a time of flight of the ultrasonic wave at a local maximum point whose received wave intensity is lowest among the plurality of local maximum points.

A non-transitory computer-readable recording medium according to one aspect of the present disclosure stores therein a program that causes a computer to execute the following, the program including: a procedure of detecting a local maximum point of a received wave intensity of a reflected wave resulting from reception of an ultrasonic wave that has been transmitted and then reflected by an object; and a procedure of calculating, when a plurality of the local maximum points is present within a range in which the received wave intensity is equal to or greater than a predetermined threshold, a distance to the object based on a time of flight of the ultrasonic wave at a local maximum point whose received wave intensity is lowest among the plurality of local maximum points.

An automatic parking control method according to one aspect of the present disclosure includes, executed by a computer: a process of detecting a local maximum point of a received wave intensity of a reflected wave resulting from reception of an ultrasonic wave that has been transmitted and then reflected by an object; a process of calculating, when a plurality of the local maximum points is present within a range in which the received wave intensity is equal to or greater than a predetermined threshold, a distance to the object based on a time of flight of the ultrasonic wave at a local maximum point whose received wave intensity is lowest among the plurality of local maximum points; and a process of causing the vehicle to automatically travel to park the vehicle in accordance with a position of the object based on the distance.

### SUMMARY OF INVENTION

### Advantageous Effects of Invention

According to the present disclosure, it is made possible to accurately measure a distance to an object even in a case where interference occurs in a reflected wave.

### BRIEF DESCRIPTION OF DRAWINGS

FIG. 1 is a schematic diagram illustrating how a reflected wave causes interference;

FIG. 2 is a diagram illustrating an exemplary configuration of a vehicle according to Embodiment 1;

FIG. 3 is a block diagram illustrating an exemplary functional configuration of a distance measuring apparatus according to Embodiment 1;

FIG. 4 is a diagram illustrating an example of a graph indicating a relationship between a received wave intensity and a time of flight;

FIG. 5 is a flowchart illustrating an operation example of the distance measuring apparatus according to Embodiment 1;

FIG. 6 is a block diagram illustrating an exemplary functional configuration of a parking assist apparatus according to Embodiment 1;

FIG. 7 is a flowchart illustrating an operation example of an entirety of the vehicle in a case where automatic parking control by the parking assist apparatus is performed on the vehicle according to Embodiment 1;

FIG. 8A is a diagram for describing how received wave intensities of a plurality of local maximum points in the graph indicating the relationship between the received wave intensity and the time of flight change due to a disturbance factor;

FIG. 8B is a diagram for describing how received wave intensities of a plurality of local maximum points in the graph indicating the relationship between the received wave intensity and the time of flight change due to a disturbance factor;

FIG. 9 is a diagram illustrating an exemplary configuration of a vehicle according to Embodiment 2;

FIG. 10 is a block diagram illustrating an exemplary functional configuration of a distance measuring apparatus according to Embodiment 2;

FIG. 11 is a flowchart illustrating an operation example of the distance measuring apparatus according to Embodiment 2; and

FIG. 12 is a diagram illustrating a hardware configuration of a computer.

### DESCRIPTION OF EMBODIMENTS

Hereinafter, each embodiment of the present disclosure will be described in detail with reference to the drawings. However, unnecessary detailed description, for example, a detailed description of well-known matters or a redundant description of substantially the same configurations may be omitted.

### Overview

In a time of flight (TOF) type distance measuring apparatus that transmits ultrasonic waves, receives ultrasonic waves reflected by an object, and calculates a distance to the object by using a time of flight of the ultrasonic waves and a sound speed, it is known that, in a case where the object has a plurality of surfaces that reflects the ultrasonic waves, reflected waves from the respective surfaces interfere with each other, and the distance measurement accuracy is reduced.

In order to accurately park a vehicle at a desired parking position on a vehicle having an automatic parking function, accurately measuring a position from the vehicle to a wheel stopper has been discussed. It is known from an experiment, a simulation, or the like that the shapes of a wheel stopper include a shape that has: an inclined surface in which a surface facing a wheel is inclined with respect to the ground; and a vertical surface perpendicular to the ground. In a case where ultrasonic waves are emitted to the wheel stopper having such a shape, the reflected waves are likely to interfere with each other.

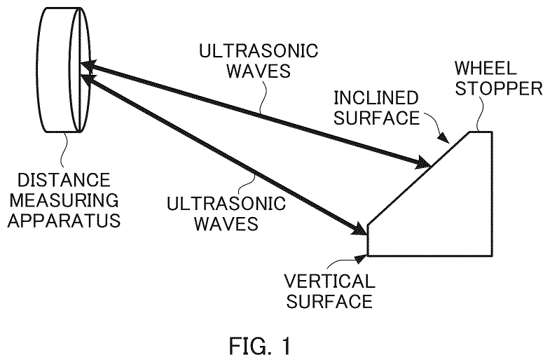

FIG. 1 is a schematic diagram illustrating how the reflected waves interfere in a wheel stopper including an inclined surface in which a surface facing a wheel is inclined with respect to the ground and a vertical surface perpendicular to the ground. FIG. 1 illustrates a cross section in a plane perpendicular to a long side of the wheel stopper.

In a case where ultrasonic waves are emitted to the wheel stopper including the inclined surface and the vertical surface and the reflected waves interfere with each other, the measured time of flight of the ultrasonic waves deviates from an actual time of flight, which possibly makes it difficult to accurately calculate a distance to the wheel stopper by using the time of flight. Specifically, it has been found from past experience that, in a case where ultrasonic waves are emitted to the wheel stopper including the inclined surface and the vertical surface and the reflected waves interfere with each other, a distance calculated based on the time of flight is longer than the actual distance.

The present disclosure provides a distance measuring apparatus, a distance measuring method, a program, and an automatic parking control method each capable of accurately measuring a distance to a wheel stopper including an inclined surface and a vertical surface even in a case where reflected waves interfere with each other due to the wheel stopper.

### Embodiment 1

First, Embodiment 1 of the present disclosure will be described.

### Overall Configuration

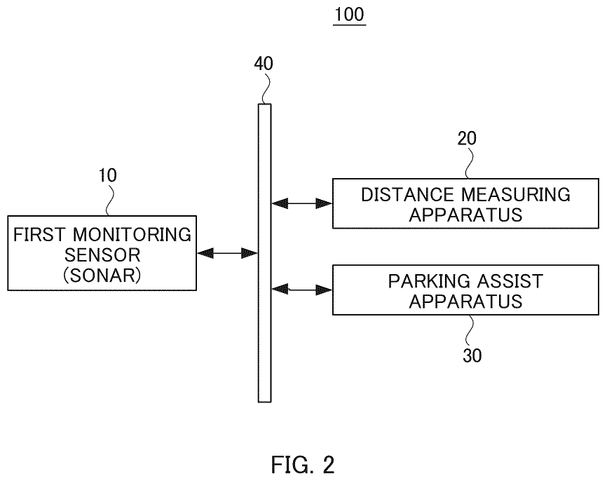

FIG. 2 is a diagram illustrating an exemplary configuration of vehicle 100 according to Embodiment 1. Vehicle 100 includes first monitoring sensor 10, distance measuring apparatus 20, parking assist apparatus 30, and in-vehicle network 40. First monitoring sensor 10 and distance measuring apparatus 20, first monitoring sensor 10 and parking assist apparatus 30, and distance measuring apparatus 20 and parking assist apparatus 30 are connected to each other via in-vehicle network 40 in a communicable state. In the example shown in FIG. 2, distance measuring apparatus 20 and parking assist apparatus 30 are illustrated as independent apparatuses, but the functional configurations thereof may be provided in the same apparatus.

First monitoring sensor 10 is a sonar sensor that transmits ultrasonic waves, receives ultrasonic waves reflected by a surrounding object of vehicle 100, and outputs a received wave intensity (wave height value (or peak value)) of the received ultrasonic waves and a time of flight (TOF) of the ultrasonic waves at each predetermined timing. The predetermined timing is, for example, a timing for each small constant time. Hereinafter, information including the received wave intensity of the received ultrasonic waves and the time of flight of the ultrasonic waves at the predetermined timing may be referred to as distance measurement event information. First monitoring sensor 10 transmits ultrasonic waves from vehicle 100 toward at least a rear side of vehicle 100. First monitoring sensor 10 is installed on, for example, a rear bumper of vehicle 100. First monitoring sensor 10 may be installed on a front bumper or left and right side surfaces of the vehicle, and may transmit ultrasonic waves forward, to the left side, or to the right side.

Distance measuring apparatus 20 measures a distance from vehicle 100 to a surrounding object based on the distance measurement event information acquired from first monitoring sensor 10. Distance measuring apparatus 20 is, for example, a computer mounted on vehicle 100.

Parking assist apparatus 30 performs automatic parking control of automatically parking vehicle 100 in a parking space based on the distance to the surrounding object measured by distance measuring apparatus 20. Parking assist apparatus 30 is, for example, a computer mounted on vehicle 100.

### Functional Configuration of Distance Measuring Apparatus 20

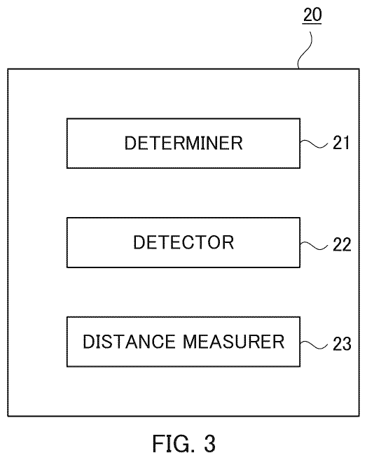

FIG. 3 is a block diagram illustrating an exemplary functional configuration of distance measuring apparatus 20 according to Embodiment 1. Distance measuring apparatus 20 includes determiner 21, detector 22, and distance measurer 23.

Determiner 21 determines whether the automatic parking control of vehicle 100 is being executed by parking assist apparatus 30. Determiner 21 may determine, for example, by receiving a signal indicating whether the automatic parking control is being executed from parking assist apparatus 30 via in-vehicle network 40.

Detector 22 generates a graph indicating a relationship between the received wave intensity and the time of flight included in the distance measurement event information for each predetermined timing based on the distance measurement event information acquired from first monitoring sensor 10, and detects a local maximum point of the received wave intensity in a range in which the received wave intensity of the graph is equal to or higher than a predetermined threshold value.

The predetermined threshold value is a value set in advance to distinguish between a road surface and a surrounding object other than the road surface. The predetermined threshold value is set in advance in a design stage of parking assist apparatus 30 by, for example, an experiment or a simulation. The local maximum point of the received wave intensity at the received wave intensity equal to or higher than the predetermined threshold value is a point that is likely to be generated by the ultrasonic waves reflected by the surrounding object other than the road surface.

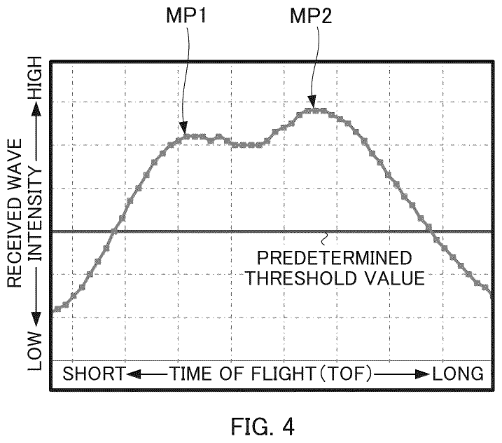

FIG. 4 is a diagram illustrating an example of a graph indicating a relationship between the received wave intensity and the time of flight. In FIG. 4, the horizontal axis indicates the time of flight, and the vertical axis indicates the received wave intensity. FIG. 4 is a graph created based on the distance measurement event information acquired in a case where the surrounding object is a wheel stopper in which a surface that stops the wheel (surface facing the wheel) includes an inclined surface and a vertical surface (see FIG. 1).

In a case where the surrounding object is a wheel stopper including an inclined surface and a vertical surface, a plurality of local maximum points of the received wave intensity may occur in a range in which the received wave intensity is equal to or higher than the predetermined threshold value due to interference of the ultrasonic waves as illustrated in FIG. 4. In the example illustrated in FIG. 4, two local maximum points MP1 and MP2 occur.

In a case where the surrounding object is a wheel stopper including an inclined surface and a vertical surface, as illustrated in FIG. 4, it is known from past experience that, among the two local maximum points generated due to interference of the ultrasonic waves, the received wave intensity of the local maximum point MP2 whose time of flight is longer is higher than the received wave intensity of the local maximum point MP1 whose time of flight is shorter.

Detector 22 detects a local maximum point of the received wave intensity in the range in which the received wave intensity is equal to or higher than the predetermined threshold value based on the relationship between the received wave intensity and the time of flight, as illustrated in FIG. 4, based on the distance measurement event information. In the following description, the local maximum point of the received wave intensity in the range in which the received wave intensity is equal to or higher than the predetermined threshold value may be simply referred to as a local maximum point.

Returning to the description of FIG. 3, distance measurer 23 calculates a distance from vehicle 100 to a surrounding object for each predetermined timing using the time of flight at a local maximum point based on the distance measurement event information acquired from first monitoring sensor 10.

In a case where there is only one local maximum point in the graph indicating the relationship between the received wave intensity and the time of flight, distance measurer 23 calculates the distance to the surrounding object, using the time of flight at the local maximum point.

In a case where there is a plurality of local maximum points in the graph indicating the relationship between the received wave intensity and the time of flight, distance measurer 23 calculates the distance to the surrounding object, using the time of flight at the local maximum point whose received wave intensity is lowest among the plurality of local maximum points.

### Operation Example of Distance Measuring Apparatus 20

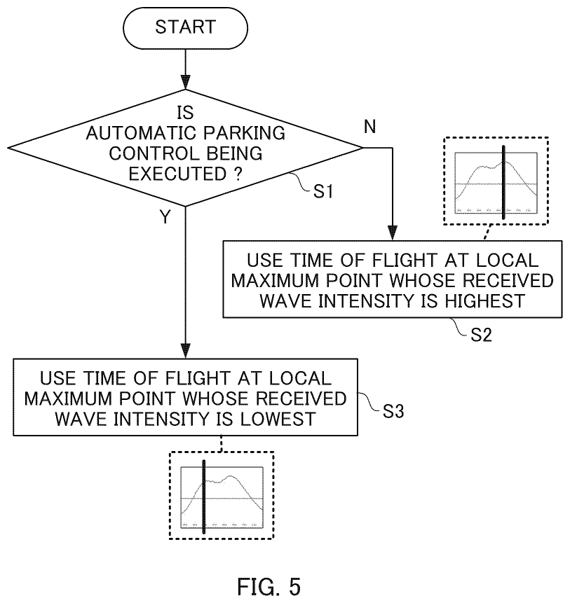

FIG. 5 is a flowchart illustrating an operation example of distance measuring apparatus 20. In the operation example of an entirety of vehicle 100 described below, the processing of distance measuring apparatus 20 illustrated in the operation example of FIG. 5 is described as a distance measurement process of a surrounding object.

In step S1, distance measuring apparatus 20 determines whether the automatic parking control of vehicle 100 is being executed. In a case where it is determined that the automatic parking control of vehicle 100 is being executed (step S1: Y), the processing proceeds to step S3, and in a case where it is determined that the automatic parking control of vehicle 100 is not being executed (step S1: N), the processing proceeds to step S2.

In step S2, distance measuring apparatus 20 calculates a distance to a surrounding object, using the time of flight at the local maximum point whose received wave intensity is highest among a plurality of local maximum points in the graph indicating the relationship between the received wave intensity and the time of flight.

In step S3, distance measuring apparatus 20 calculates the distance to the surrounding object, using the time of flight at the local maximum point whose received wave intensity is lowest among the plurality of local maximum points in the graph indicating the relationship between the received wave intensity and the time of flight.

Specific examples of the time of flight at the local maximum point used in calculating the distance in respective steps are indicated by thick lines in the broken line frames associated with steps S2 and S3 of FIG. 5. As described above, distance measuring apparatus 20 changes the local maximum point used in calculating the distance depending on whether the automatic parking control of vehicle 100 is being executed. As a result, the following effects are obtained.

In a case where the automatic parking control of vehicle 100 is not being executed, distance measuring apparatus 20 calculates a distance to a surrounding object, using the time of flight at the local maximum point whose received wave intensity is highest among a plurality of local maximum points, for example, the local maximum point whose intensity of the received ultrasonic waves is highest. In a case where the automatic parking control is not being executed, the interference of the ultrasonic waves generated by the wheel stopper having an inclined surface does not need to be considered, so that the distance having the highest received wave intensity and the highest possibility of the presence of the object can be calculated as the distance to the surrounding object.

Meanwhile, in a case where the automatic parking control of vehicle 100 is being executed, distance measuring apparatus 20 calculates a distance to a surrounding object using the time of flight at the local maximum point whose received wave intensity is lowest among a plurality of local maximum points. As described above, it is known that, in a case where the distance to the surrounding object in which the interference of the ultrasonic waves is likely to occur is calculated, using the time of flight at the local maximum point whose received wave intensity is highest, the distance is calculated to be longer than the actual distance. With distance measuring apparatus 20 according to Embodiment 1, the distance is calculated, using the time of flight at the local maximum point whose received wave intensity is lowest in consideration of the interference of the ultrasonic waves generated by the wheel stopper including an inclined surface and a vertical surface, so that such a situation can be avoided.

### Functional Configuration of Parking Assist Apparatus 30

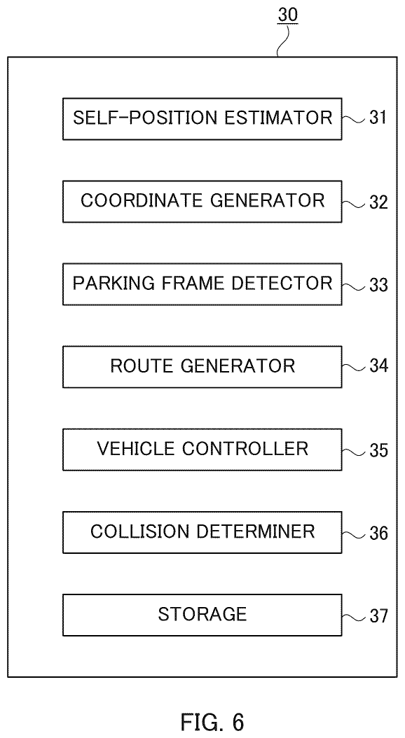

FIG. 6 is a block diagram illustrating an exemplary functional configuration of parking assist apparatus 30. Parking assist apparatus 30 includes self-position estimator 31, coordinate generator 32, parking frame detector 33, route generator 34, vehicle controller 35, collision determiner 36, and storage 37. In the present embodiment, after the start of the parking support (automatic parking) control, parking assist apparatus 30 extracts a parking frame as a target parking position from an image captured by a camera mounted on vehicle 100, generates a route for the vehicle to travel from a predetermined position (parking start position) to the target parking position, compares the generated route with an actual traveling position to make correction, and causes the vehicle to travel to the target parking position.

Self-position estimator 31 estimates the position and the orientation of vehicle 100 in a case where parking assist apparatus 30 performs automatic parking control on vehicle 100. For example, self-position estimator 31 reads out feature point information of a surrounding environment map read out from storage 37 and compares the feature points with feature points based on information indicating the surrounding environment acquired by first monitoring sensor 10 and/or a surrounding image acquired by a camera mounted on vehicle 100 to estimate the position and the orientation of vehicle 100 during reproduction travel.

Coordinate generator 32 generates coordinate information of a surrounding object based on the distance information to the surrounding object acquired from distance measuring apparatus 20, with reference to vehicle 100.

The coordinate information is, for example, information of an XY coordinate system. The X coordinates are a position coordinate in a traveling direction (hereinafter, also referred to as an X direction) of vehicle 100 in automatic parking. The Y coordinates are a position coordinate in a direction orthogonal to the traveling direction and in a direction perpendicular to a side surface of vehicle 100 (hereinafter, also referred to as a Y direction).

For example, coordinate generator 32 generates coordinate information of a surrounding object based on the principle of triangulation.

Parking frame detector 33 detects a space (parking frame) in which vehicle 100 is parked by automatic parking control based on the information indicating the surrounding environment acquired by first monitoring sensor 10 and/or the surrounding image acquired by the camera mounted on vehicle 100.

Route generator 34 generates a route for moving vehicle 100 from the current position to the parking frame without collision with the surrounding object based on the position information of vehicle 100 estimated by self-position estimator 31, the coordinate information of the surrounding object generated by coordinate generator 32, and the position information of the parking frame detected by parking frame detector 33. In a case where each type of information changes while vehicle controller 35 causes vehicle 100 to automatically travel along the generated route, route generator 34 may update the route based on the changed information.

Vehicle controller 35 performs control of causing vehicle 100 to automatically travel along the route generated by route generator 34.

Collision determiner 36 determines whether collision with the surrounding object occurs during the automatic traveling by vehicle controller 35. Collision determiner 36 determines the presence or absence of collision based on the distance information to the surrounding object acquired from distance measuring apparatus 20.

In a case where collision determiner 36 determines collision with the surrounding object occurs, vehicle controller 35 stops the automatic traveling or decelerates the vehicle. Vehicle controller 35 decelerates vehicle 100 as vehicle 100 approaches the wheel stopper, based on the distance to the wheel stopper measured by distance measuring apparatus 20. Vehicle controller 35 performs control of the automatic traveling such that the wheels of vehicle 100 stop in front of the wheel stopper. It should be noted that whether the surrounding object of which the distance is measured by distance measuring apparatus 20 is the wheel stopper may be determined based on, for example, the surrounding image acquired by the camera mounted on vehicle 100.

Storage 37 stores each type of information in a case where parking assist apparatus 30 performs automatic parking control on vehicle 100.

### Operation Example When Performing Automatic Parking Control in Vehicle 100

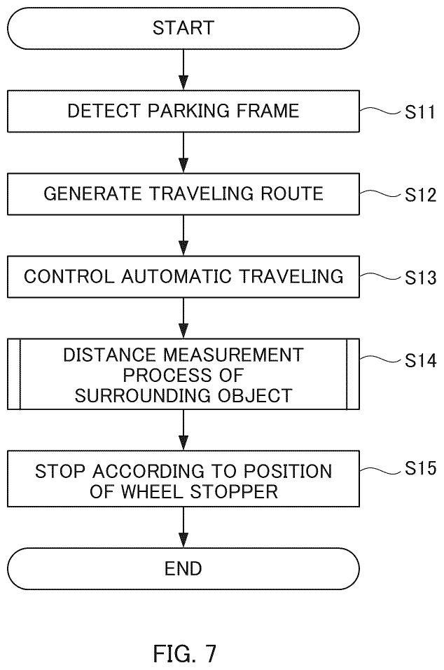

FIG. 7 is a flowchart illustrating an operation example of the entirety of vehicle 100 in a case where automatic parking control by parking assist apparatus 30 is performed in vehicle 100 according to Embodiment 1.

In step S11, parking assist apparatus 30 detects a parking frame based on information related to a surrounding environment acquired from first monitoring sensor 10 or a surrounding image acquired from a camera mounted on vehicle 100.

In step S12, parking assist apparatus 30 generates a traveling route of vehicle 100 based on position information of vehicle 100, coordinate information of a surrounding object, and position information of the parking frame.

In step S13, parking assist apparatus 30 controls vehicle 100 to automatically travel based on the route generated in step S12. It should be noted that, even while parking assist apparatus 30 performs the control of causing vehicle 100 to automatically travel, in a case where each type of information for generating the route changes, parking assist apparatus 30 may update the route based on the changed information and perform the automatic traveling control based on the updated route.

In step S14, distance measuring apparatus 20 executes a distance measurement process of measuring a distance to a surrounding object. The content of the distance measurement process in step S14 is as described in FIG. 5.

In step S15, parking assist apparatus 30 performs automatic traveling control such that vehicle 100 is stopped according to the wheel stopper based on the distance to the wheel stopper acquired in step S14.

With the operation described above, vehicle 100 can be automatically parked accurately in accordance with the position of the wheel stop. In the distance measurement process in step S14, as described in association with FIG. 5, distance measuring apparatus 20 calculates the distance to the wheel stopper, using the time of flight of the local maximum point whose received wave intensity is lowest, when the vehicle is under the automatic parking control. As a result, distance measuring apparatus 20 can accurately calculate the distance to the wheel stopper even in a case where the wheel stopper includes an inclined surface and a vertical surface and interference occurs in the ultrasonic waves reflected by the wheel stopper.

### Embodiment 2

Next, Embodiment 2 of the present disclosure will be described. In the description of Embodiment 2, the same configurations as those of Embodiment 1 will be designated by the same reference numerals and will not be described. In addition, in the description of Embodiment 2, even in a case where the same configuration as that of Embodiment 1 is used while the operation is different, the reference numeral is designated by “A” and will be described.

It is known that, in a case where there is a disturbance factor, such as wind, the ultrasonic waves transmitted through the air are also affected. For example, in a case where there is a disturbance factor, such as wind, the received wave intensity in reception of the ultrasonic waves reflected from an object at the same position may be lower or higher than that in a case where there is no disturbance factor.

In Embodiment 2, in consideration of a case where such a disturbance factor is present, the distance measuring apparatus measures a distance to a surrounding object, using the time of flight of the local maximum point whose time of flight is shortest among a plurality of local maximum points in a graph indicating a relationship between the received wave intensity and the time of flight.

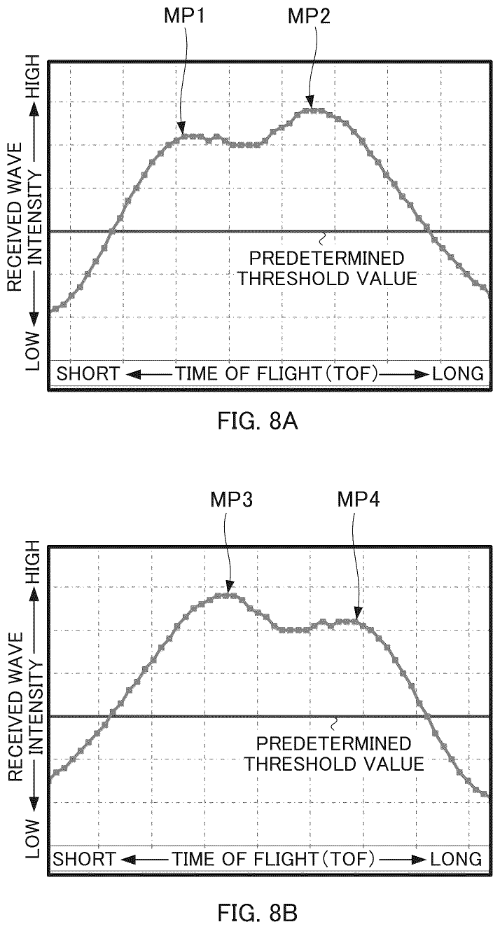

FIGS. 8A and 8B are diagrams for describing how the received wave intensities of the plurality of local maximum points in the graph indicating the relationship between the received wave intensity and the time of flight change due to the disturbance factor. FIGS. 8A and 8B are graphs generated based on the distance measurement event information acquired in a case where the surrounding object is a wheel stopper (see FIG. 1) in which a surface that stops the wheel (surface facing the wheel) includes an inclined surface and a vertical surface, as in FIG. 4. FIGS. 8A and 8B are graphs obtained by transmitting ultrasonic waves to the wheel stopper from the same distance and receiving the reflected ultrasonic waves.

FIG. 8A is the same graph as that of FIG. 4, and is a graph based on a measurement result in an environment in which a disturbance factor, such as wind can be ignored. FIG. 8A illustrates an example in which, in a range in which the received wave intensity is equal to or higher than a predetermined threshold value, the received wave intensity of the local maximum point MP1 whose time of flight is shorter is lower than the received wave intensity of the local maximum point MP2 whose time of flight is longer.

Meanwhile, FIG. 8B is a graph based on a measurement result in an environment in which the influence of the disturbance factor, such as wind is larger than that in the example of FIG. 8A. In FIG. 8B, in a range in which the received wave intensity is equal to or higher than the predetermined threshold value, the received wave intensity of the local maximum point MP3 whose time of flight is shorter is higher than the received wave intensity of the local maximum point MP4 whose time of flight is longer.

As described above, even in the same measurement condition, the received wave intensity may change due to the disturbance factor, such as wind.

Herein, let us consider calculating a distance to a surrounding object, using the distance measuring method of distance measuring apparatus 20 described in Embodiment 1 when a disturbance factor, such as wind is large as illustrated in FIG. 8B. Let us consider a case where the received wave intensity of the local maximum point MP3 whose time of flight is shorter is higher than the received wave intensity of the local maximum point MP4 whose time of flight is longer as illustrated in FIG. 8B. In this case, as described in Embodiment 1, calculating the distance, using the local maximum point whose received wave intensity is lowest among a plurality of local maximum points results in calculating the distance, using the time of flight of the local maximum point MP4 whose time of flight is longer. In a case where the distance is calculated, using the local maximum point whose time of flight is longer, the distance to the surrounding object is possibly calculated to be longer than the actual distance.

For this reason, in Embodiment 2, in consideration of a case where the disturbance factor, such as, wind is large, the distance is calculated, using the time of flight of the local maximum point whose time of flight is shortest among a plurality of local maximum points. As a result, in the example illustrated in FIG. 8A, the time of flight at the local maximum point MP1 is used, which is the same as in the description of Embodiment 1. Further, in the example illustrated in FIG. 8B, the time of flight at the local maximum point MP3 is used, and the distance that is close to the actual distance can be calculated as compared to a case where the distance is calculated, using the time of flight at the local maximum point MP4.

However, it is known that the distance measuring method of measuring a distance to a surrounding object using the time of flight of the local maximum point whose time of flight is shortest among a plurality of local maximum points can be applied to a case where the wheel stopper has the inclined surface and the vertical surface as in FIG. 1 and the interference occurs in the reflected ultrasonic waves, but it is difficult to apply the distance measuring method to a case of a shape in which the interference is unlikely to occur in the reflected ultrasonic waves, for example, a case where the entire shape of the wheel stopper is substantially a rectangular parallelepiped. This is because, adopting the distance measuring method of measuring a distance to a surrounding object, using the time of flight of the local maximum point whose time of flight is shortest for the surrounding object having a shape in which the interference is unlikely to occur is likely to result in calculating the distance to be shorter than the actual distance.

Therefore, in Embodiment 2, the shape of the surrounding object is identified as being a wheel stopper including an inclined surface and a vertical surface or not based on a surrounding image acquired from a camera, and the local maximum point used in calculating the distance is changed based on a result of the identification. Hereinafter, the configuration and the operation in Embodiment 2 will be described.

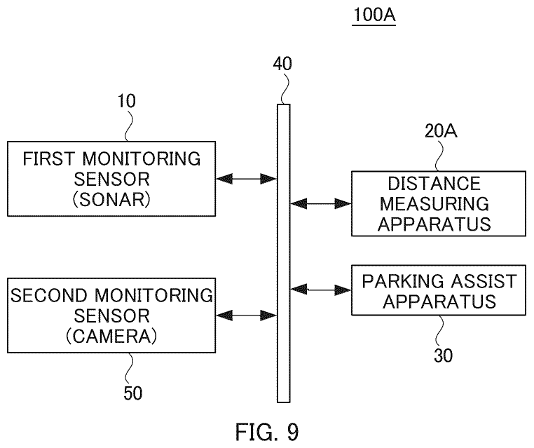

FIG. 9 is a diagram illustrating an exemplary configuration of vehicle 100A according to Embodiment 2. As illustrated in FIG. 9, vehicle 100A according to Embodiment 2 includes first monitoring sensor 10, distance measuring apparatus 20A, parking assist apparatus 30, in-vehicle network 40, and second monitoring sensor 50.

Second monitoring sensor 50 includes a camera that captures an image of surroundings of vehicle 100A and outputs a surrounding image of vehicle 100A.

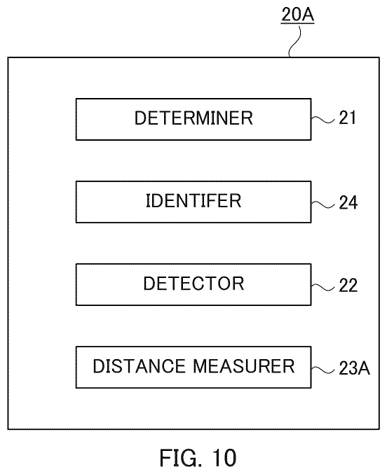

FIG. 10 is a block diagram illustrating an exemplary functional configuration of distance measuring apparatus 20A according to Embodiment 2.

As illustrated in FIG. 10, distance measuring apparatus 20A according to Embodiment 2 includes identifier 24.

Identifier 24 identifies a surrounding object in the traveling direction of vehicle 100 based on the surrounding image acquired from second monitoring sensor 50 (camera). Identifier 24 identifies whether or not the surrounding object is a wheel stopper in which a surface facing the wheel includes an inclined surface and a vertical surface (see FIG. 1).

In a case where there is only one local maximum point in a graph indicating the relationship between the received wave intensity and the time of flight, distance measurer 23A calculates the distance to the surrounding object, using the time of flight at the local maximum point.

In a case where there is a plurality of local maximum points in the graph indicating the relationship between the received wave intensity and the time of flight, distance measurer 23A changes the local maximum point used in calculating the distance based on a result of the identification of identifier 24.

In a case where the surrounding object is a wheel stopper including an inclined surface and a vertical surface based on the result of identification of identifier 24, distance measurer 23A calculates the distance to the surrounding object, using the time of flight of the local maximum point whose time of flight is shortest among a plurality of local maximum points.

In addition, in a case where the surrounding object is not the wheel stopper including an inclined surface and a vertical surface based on the result of identification of identifier 24, distance measurer 23A calculates the distance to the surrounding object, using the time of flight of the local maximum point whose received wave intensity is lowest among a plurality of local maximum points.

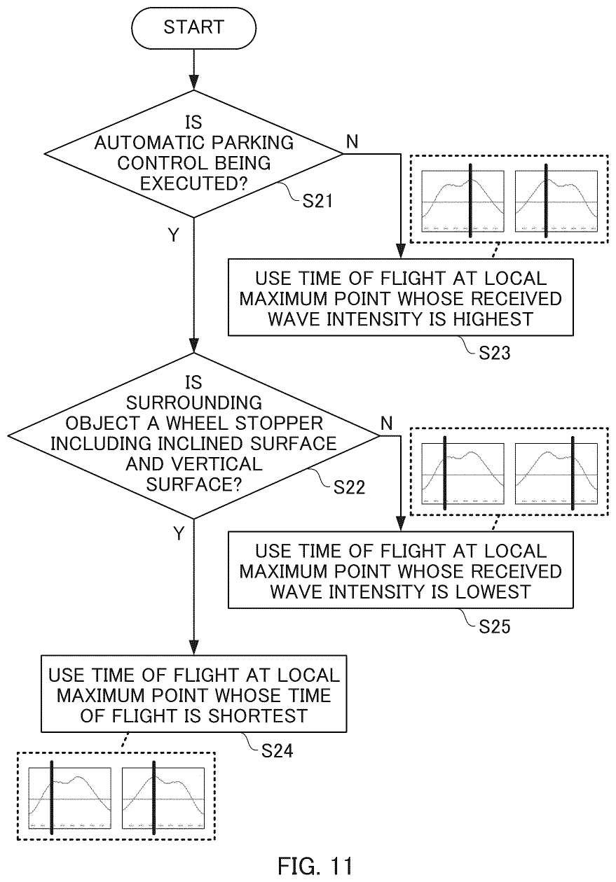

FIG. 11 is a flowchart illustrating an operation example of distance measuring apparatus 20A according to Embodiment 2.

In step S21, distance measuring apparatus 20A determines whether the automatic parking control of vehicle 100 is being executed. In a case where it is determined that the automatic parking control of vehicle 100 is being executed (step S21: Y), the processing proceeds to step S22, and in a case where it is determined that the automatic parking control of vehicle 100 is not being executed (step S21: N), the processing proceeds to step S23.

In step S22, distance measuring apparatus 20A determines whether a surrounding object is identified as a wheel stopper (see FIG. 1) including an inclined surface and a vertical surface. In a case where the surrounding object is identified as a wheel stopper including an inclined surface and a vertical surface (step S22: Y), the processing proceeds to step S24, and in a case where the surrounding object is not identified as the wheel stopper including an inclined surface and a vertical surface (step S22: N), the processing proceeds to step S25.

The case where the surrounding object is not identified as a wheel stopper including an inclined surface and a vertical surface includes, for example, a case where the surrounding object is identified as a wheel stopper which has the entire shape being a rectangular parallelepiped and in which the surface facing the wheel is composed of a vertical surface (wheel stopper including no inclined surface).

In step S23, distance measurer 23A calculates the distance to the object, using the time of flight at the local maximum point whose received wave intensity is highest among a plurality of local maximum points at the received wave intensity equal to or higher than a predetermined threshold value in the graph indicating the relationship between the received wave intensity and the time of flight.

In step S24, distance measurer 23A calculates the distance to the object, using the time of flight at the local maximum point whose time of flight is shortest among the plurality of local maximum points at the received wave intensity equal to or higher than the predetermined threshold value in the graph indicating the relationship between the received wave intensity and the time of flight.

In step S25, distance measurer 23A calculates the distance to the object, using the time of flight at the local maximum point whose received wave intensity is lowest among the plurality of local maximum points at the received wave intensity equal to or higher than the predetermined threshold value in the graph indicating the relationship between the received wave intensity and the time of flight.

Specific examples of the time of flight of the local maximum point used in calculating the distance in each step are indicated by thick lines in the broken line frames associated with steps S23, S24, and S25 of FIG. 11. As described above, distance measuring apparatus 20A changes the local maximum point used in calculating the distance depending on whether the automatic parking control of vehicle 100A is being executed. In addition, distance measuring apparatus 20A changes the local maximum point used in calculating the distance depending on whether the surrounding object is the wheel stopper including an inclined surface and a vertical surface. As a result, the following effects are obtained.

In a case where the automatic parking control of vehicle 100A is not being executed, distance measuring apparatus 20A calculates the distance to a surrounding object using the time of flight at the local maximum point whose received wave intensity is highest among a plurality of local maximum points, for example, the local maximum point whose intensity of the received ultrasonic waves is highest. In a case where the automatic parking control is not being executed, the interference of the ultrasonic waves generated by the wheel stopper having an inclined surface does not need to be considered, so that the distance having the highest received wave intensity and the highest possibility of the presence of the surrounding object can be calculated as the distance to the surrounding object.

In a case where the automatic parking control of vehicle 100A is being executed and the surrounding object is a wheel stopper including an inclined surface and a vertical surface, distance measuring apparatus 20A calculates the distance to the surrounding object, using the time of flight at the local maximum point whose time of flight is shortest among a plurality of local maximum points. As described above, in a case where a disturbance factor, such as wind is large, calculating the distance, using the time of flight at the local maximum point whose received wave intensity is lowest as in Embodiment 1 results in calculating the distance to be longer than the actual distance in some cases. Distance measuring apparatus 20A according to Embodiment 2 calculates the distance to the surrounding object, using the time of flight at the local maximum point whose time of flight is shortest in consideration of a case where the disturbance factor is large, so that the distance to the wheel stopper can be accurately calculated.

In addition, in a case where the automatic parking control of vehicle 100A is being executed and the surrounding object is not the wheel stopper including an inclined surface and a vertical surface, distance measuring apparatus 20A calculates the distance to the surrounding object, using the time of flight at the local maximum point whose received wave intensity is lowest among a plurality of local maximum points. Measuring the distance to the surrounding object, using the time of flight of the local maximum point whose time of flight is shortest when the surrounding object is not the wheel stopper including an inclined surface and a vertical surface results in calculating the distance to be shorter than the actual distance in some cases. According to distance measuring apparatus 20A, such a situation can be prevented.

### Example of Hardware Configuration of Computer

Distance measuring apparatuses 20 and 20A and parking assist apparatus 30 described in the above embodiments are computers, and the functional configurations thereof are realized by the computer executing a predetermined program. Hereinafter, an example of a hardware configuration of a computer that realizes each function of distance measuring apparatuses 20 and 20A and parking assist apparatus 30 will be described.

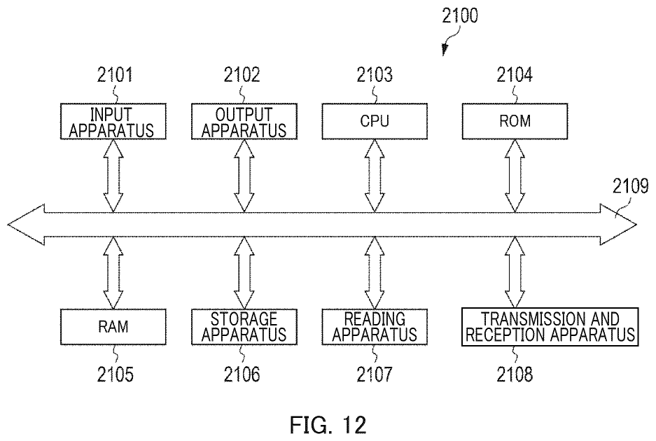

FIG. 12 is a diagram illustrating a hardware configuration of computer 2100. As illustrated in FIG. 12, computer 2100 includes input apparatus 2101, such as an input button and a touchpad, output apparatus 2102, such as a display and a speaker, central processing unit (CPU) 2103, read only memory (ROM) 2104, and random access memory (RAM) 2105. In addition, computer 2100 includes storage apparatus 2106 such as a hard disk apparatus and a solid state drive (SSD), reading apparatus 2107 that reads information from a recording medium such as a digital versatile disk read only memory (DVD-ROM) and a universal serial bus (USB) memory, and a transmission and reception apparatus 2108 that communicates via a network. The above-described units are connected to each other by bus 2109.

Reading apparatus 2107 reads a program for realizing the functions of the above-described units from the recording medium on which the program is recorded, and stores the program in storage apparatus 2106. Alternatively, the transmission and reception apparatus 2108 communicates with a server apparatus connected to the network, and stores the program for realizing the functions of the above-described units, which is downloaded from the server apparatus, in storage apparatus 2106.

CPU 2103 copies the program stored in storage apparatus 2106 to RAM 2105 and sequentially reads out and executes the commands included in the program from RAM 2105 to realize the functions of the above-described units. In addition, in execution of the program, the information obtained in the various processes described in each embodiment is stored in RAM 2105 or storage apparatus 2106 and is appropriately used.

The expressions “ . . . processor”, “ . . . -er”, “ . . . -or”, and “ . . . -ar” in each embodiment described above may be replaced with other expressions such as “ . . . circuitry”, “ . . . assembly”, “ . . . device”, “ . . . unit”, or “ . . . module”.

The present application claims the benefit and priority of Japanese Patent Application No. 2024-230262 filed on Dec. 26, 2024, the entire disclosure of which, including the specification, drawings, and abstracts, is incorporated herein by reference.

### INDUSTRIAL APPLICABILITY

The present disclosure is useful for a distance measuring apparatus that performs a distance measurement process via transmission and reception of ultrasonic waves.

1. A distance measuring apparatus, comprising:
a detect circuitry which, in operation, detects a local maximum point of a received wave intensity of a reflected wave resulting from reception of an ultrasonic wave that has been transmitted and then reflected by an object; and
a distance measure circuitry which, in operation, calculates, when a plurality of the local maximum points is present within a range in which the received wave intensity is equal to or greater than a predetermined threshold, a distance to the object based on a time of flight of the ultrasonic wave at a local maximum point whose received wave intensity is lowest among the plurality of local maximum points.

2. The distance measuring apparatus according to claim 1, wherein, the distance measure circuitry which, in operation, calculates the distance to the object based on the time of flight at a local maximum point whose received wave intensity is lowest or a local maximum point whose time of flight is shortest among the plurality of local maximum points.

3. The distance measuring apparatus according to claim 1, further comprising: a determine circuitry which, in operation, determines whether automatic parking control for a vehicle is being executed, wherein,
the distance measure circuitry which, in operation, calculates, when the automatic parking control is not being executed, the distance from the vehicle to the object based on the time of flight at a local maximum point whose received wave intensity is highest among the plurality of local maximum points, and
the distance measure circuitry which, in operation, calculates, when the automatic parking control is being executed, the distance based on the time of flight at a local maximum point whose received wave intensity is lowest or a local maximum point whose time of flight is shortest among the plurality of local maximum points.

4. The distance measuring apparatus according to claim 3, wherein,
the distance measure circuitry which, in operation, calculates, when the object is a wheel stopper, the distance based on the time of flight at a local maximum point whose received wave intensity is lowest among the plurality of local maximum points, the wheel stopper being a wheel stopper in which a surface of the wheel stopper facing a wheel does not include an inclined surface inclined with respect to the ground, and
the distance measure circuitry which, in operation, calculates, when the object is a wheel stopper, the distance based on the time of flight at a local maximum point whose time of flight is shortest among the plurality of local maximum points, the wheel stopper being a wheel stopper in which a surface of the wheel stopper facing a wheel includes the inclined surface.

5. A distance measuring method, comprising, executed by a computer:
a process of detecting a local maximum point of a received wave intensity of a reflected wave resulting from reception of an ultrasonic wave that has been transmitted and then reflected by an object; and
a process of calculating, when a plurality of the local maximum points is present within a range in which the received wave intensity is equal to or greater than a predetermined threshold, a distance to the object based on a time of flight of the ultrasonic wave at a local maximum point whose received wave intensity is lowest among the plurality of local maximum points.

6. The distance measuring method according to claim 5, wherein, the process of calculating includes calculating the distance to the object based on the time of flight at a local maximum point whose received wave intensity is lowest or a local maximum point whose time of flight is shortest among the plurality of local maximum points.

7. The distance measuring method according to claim 5, further comprising: a process of determining whether automatic parking control for a vehicle is being executed, the process being executed by the computer, wherein,
the process of calculating includes:
calculating, when the automatic parking control is not being executed, the distance from the vehicle to the object based on the time of flight at a local maximum point whose received wave intensity is highest among the plurality of local maximum points; and
calculating, when the automatic parking control is being executed, the distance based on the time of flight at a local maximum point whose received wave intensity is lowest or a local maximum point whose time of flight is shortest among the plurality of local maximum points.

8. The distance measuring method according to claim 7, wherein the process of calculating includes:
calculating, when the object is a wheel stopper, the distance based on the time of flight at a local maximum point whose received wave intensity is lowest among the plurality of local maximum points, the wheel stopper being a wheel stopper in which a surface of the wheel stopper facing a wheel does not include an inclined surface inclined with respect to the ground; and
calculating, when the object is a wheel stopper, the distance based on the time of flight at a local maximum point whose time of flight is shortest among the plurality of local maximum points, the wheel stopper being a wheel stopper in which a surface of the wheel stopper facing a wheel includes the inclined surface.

9. A non-transitory computer-readable recording medium storing therein a program that causes a computer to execute the following, the program comprising:
a procedure of detecting a local maximum point of a received wave intensity of a reflected wave resulting from reception of an ultrasonic wave that has been transmitted and then reflected by an object; and
a procedure of calculating, when a plurality of the local maximum points is present within a range in which the received wave intensity is equal to or greater than a predetermined threshold, a distance to the object based on a time of flight of the ultrasonic wave at a local maximum point whose received wave intensity is lowest among the plurality of local maximum points.

10. The non-transitory computer-readable recording medium according to claim 9, wherein, the procedure of calculating includes calculating the distance to the object based on the time of flight at a local maximum point whose received wave intensity is lowest or a local maximum point whose time of flight is shortest among the plurality of local maximum points.

11. The non-transitory computer-readable recording medium according to claim 9, the program further comprising a procedure of determining whether automatic parking control for a vehicle is being executed, wherein,
the procedure of calculating includes:
calculating, when the automatic parking control is not being executed, the distance from the vehicle to the object based on the time of flight at a local maximum point whose received wave intensity is highest among the plurality of local maximum points; and
calculating, when the automatic parking control is being executed, the distance based on the time of flight at a local maximum point whose received wave intensity is lowest or a local maximum point whose time of flight is shortest among the plurality of local maximum points.

12. The non-transitory computer-readable recording medium according to claim 11, wherein, the procedure of calculating includes:
calculating, when the object is a wheel stopper, the distance based on the time of flight at a local maximum point whose received wave intensity is lowest among the plurality of local maximum points, the wheel stopper being a wheel stopper in which a surface of the wheel stopper facing a wheel does not include an inclined surface inclined with respect to the ground; and
calculating, when the object is a wheel stopper, the distance based on the time of flight at a local maximum point whose time of flight is shortest among the plurality of local maximum points, the wheel stopper being a wheel stopper in which a surface of the wheel stopper facing a wheel includes the inclined surface.

13. An automatic parking control method, comprising, executed by a computer:
a process of detecting a local maximum point of a received wave intensity of a reflected wave resulting from reception of an ultrasonic wave that has been transmitted and then reflected by an object;
a process of calculating, when a plurality of the local maximum points is present within a range in which the received wave intensity is equal to or greater than a predetermined threshold, a distance to the object based on a time of flight of the ultrasonic wave at a local maximum point whose received wave intensity is lowest among the plurality of local maximum points; and
a process of causing the vehicle to automatically travel to park the vehicle in accordance with a position of the object based on the distance.

14. The automatic parking control method according to claim 13, wherein, the process of calculating includes calculating the distance to the object based on the time of flight at a local maximum point whose received wave intensity is lowest or a local maximum point whose time of flight is shortest among the plurality of local maximum points.

15. The automatic parking control method according to claim 13, further comprising a process of determining whether automatic parking control for a vehicle is being executed, wherein,
the process of calculating includes:
calculating, when the automatic parking control is not being executed, the distance from the vehicle to the object based on the time of flight at a local maximum point whose received wave intensity is highest among the plurality of local maximum points; and
calculating, when the automatic parking control is being executed, the distance based on the time of flight at a local maximum point whose received wave intensity is lowest or a local maximum point whose time of flight is shortest among the plurality of local maximum points.

16. The automatic parking control method according to claim 15, wherein, the process of calculating includes:
calculating, when the object is a wheel stopper, the distance based on the time of flight at a local maximum point whose received wave intensity is lowest among the plurality of local maximum points, the wheel stopper being a wheel stopper in which a surface of the wheel stopper facing a wheel does not include an inclined surface inclined with respect to the ground; and
calculating, when the object is a wheel stopper, the distance based on the time of flight at a local maximum point whose time of flight is shortest among the plurality of local maximum points, the wheel stopper being a wheel stopper in which a surface of the wheel stopper facing a wheel includes the inclined surface.
